(19) United States
(12) Patent Application Publication
(10) Pub. No.: US 2013/0006683 A1
(43) Pub. Date: Jan. 3, 2013

(54) SYSTEM AND METHOD OF MANAGING TESTING FOR A HEALTHCARE SYSTEMS TRANSITION

(75) Inventor: Gururaj B. Rao, Mumbai (IN)

(73) Assignee: Infosys Limited, Bangalore (IN)

(21) Appl. No.: 13/245,729

(22) Filed: Sep. 26, 2011

(30) Foreign Application Priority Data
Jun. 30, 2011 (IN) 2218/CHE/2011

(51) Int. Cl. G06Q 10/00

(52) U.S. Cl. 705/7.11

(57) ABSTRACT

Systems and a methods for managing a health care systems transition are described. Transitions can include a migration from Health Insurance Portability and Accountability Act (HIPAA) Electronic Data Interchange (EDI) 4010 standards set to the HIPAA EDI 5010 standards set. An example implementation describes selecting at least two test-case scenarios for inclusion in a test-case that models a healthcare systems transition, linking said scenarios, identifying test data associated with the test-case and, finally, generating an EDI file based on these scenarios and data. Additional embodiments disclosed include inferring one or more scenarios from an EDI file and importing the scenarios thereby. Some embodiments additionally disclose the creation of a correlation database and identifying data instances for inclusion in the test-case thereby. Finally, in some embodiments, scenarios and data associated with a test-case can be predefined.

### CROSS REFERENCE TO RELATED APPLICATION

This application claims the benefit of and priority to prior Indian patent application number 2218/CHE/2011, entitled “SYSTEM AND METHOD OF MANAGING TESTING FOR A HEALTHCARE SYSTEMS TRANSITION,” filed on Jun. 30, 2011, the entire disclosure of which is hereby incorporated herein by reference.

### FIELD

The field relates generally to testing of transactions in healthcare systems. In particular, the field relates to the management of transaction testing in the context of one or more Health Insurance Portability and Accountability Act (hereinafter ‘HIPAA’) electronic data interchange standards (‘EDI’) compliant transaction scenarios.

### BACKGROUND

HIPAA EDI standards compliance is a large and complicated task for any healthcare or health service provider. Migration from the HIPAA EDI 4010 standards set to the HIPAA EDI 5010 standards set, for example, is a huge, and expensive, task that involves an analysis of standards compliance requirements, a corresponding analysis of the magnitude of change from the provider's extant practice that is done for such compliance, and a willingness to confront and deal with any of a multitude of challenges involved in an implementation that bridges the gap. Rough industry estimates have, for example, placed the cost of a 5010 implementation at as much as 20% of implementing the last HIPAA EDI iteration.

Transitions of this nature are generally done in a phased manner, and include, invariably, planning, execution, and testing. While determining the impact of these changes is a challenge in itself, possible ramifications can include a significant, organization wide, impact that affects people, processes and systems, thereby making the need for an orderly and effective transition paramount.

Additionally, it can be difficult for medical professionals to prepare or transfer test case scenarios, as traditional tools and approaches to transaction testing in the HIPAA compliance environment are limited.

### SUMMARY

A computer implemented method for managing testing for a healthcare systems transition is described. Some aspects of the method can comprise selecting a first test-case scenario, wherein a scenario is a set of business specific rules that control a test-case, identifying a second scenario to be linked to the first scenario linking the first and second scenarios, identifying test data that is to be associated with the test-case scenarios, and generating one or more EDI files from the linked scenarios and the test data.

In an additional embodiment, a system for managing transaction testing is disclosed, the system comprising a processor readable storage medium in communication with a processor, wherein the processor readable storage medium contains one or more programming instructions whereby the processor is operably configured to implement a scenario management module adapted to manage one or more test-case scenarios, and the management of one or more scenarios can comprise selection of a first test-case scenario, wherein a scenario is a set of business specific rules that control a test-case, identification of a second scenario to be linked to the first scenario, linking the first and second scenarios. The system can additionally comprise a data management module adapted to identify data to be used in combination with the one or more test-case scenarios and a file generation module adapted to generate one or more electronic data interchange files.

The foregoing and other objects, features, and advantages of the technologies will become more apparent from the following detailed description, which proceeds with reference to the accompanying figures.

### BRIEF DESCRIPTION OF THE DRAWINGS

FIG. 1 is a computer architecture diagram illustrating a computing system capable of implementing the embodiments presented herein.

FIG. 2 is an illustration of a computing environment in which a system for managing a healthcare systems transition is represented.

FIG. 3 is a flow diagram illustrating a method of managing a healthcare systems transition.

FIG. 4 is a flow diagram illustrating an aspect of an embodiment provided herein for inferring a scenario for a healthcare systems transition.

FIG. 5 is a flow diagram of an aspect of an embodiment provided herein, detailing the identification of data to be used for generating an output.

FIG. 6 is a flow diagram illustrating an aspect of an embodiment provided herein that details the correlation of one or more data entities.

### DETAILED DESCRIPTION

The following description is the full and informative description of the best method and system presently contemplated for carrying out the herein presently described technologies which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique can be implemented with either greater or lesser specificity, depending on the needs of the user. Further, some of the features of the present technique can be used to get an advantage without the corresponding use of other features described in the following paragraphs. As such, the present description should be considered as merely illustrative of the principles of the present technique and not in limitation thereof, since the present technique is defined by the claims.

The transition of healthcare systems to mandated HIPAA 5010 standards present opportunities and challenges that impact people, processes and systems in healthcare organizations. Implementing such a transition, however, can involve a great deal of cost, in time and effort. Industry estimates, for example, put the cost of 5010 implementation at around 20% of the cost of the previous 4010 standards transition. At the same time, implementing HIPAA 5010 as a mere regulation set dilutes the potential inherent in leveraging this process to improve the efficiency of healthcare delivery and administration. Opportunities exist, for example, to implement greater automation in referral, eligibility and claim inquiry, improve efficiency in claim payments through the use of more accurate and granular codes, as well as to improve interoperability in healthcare. A significant way to achieve each of these is to implement a clean systems transition—a task that is possible when the systems transition is backed up by a robust systems testing approach.

A typical HIPAA transaction involves the exchange of data between two or more trading partners—this data is, as evident, in a standards compliant EDI (electronic data interchange) format. A variety of transaction types are specified accordingly, such as an eligibility inquiry, which is assigned the number 270, and the corresponding eligibility response, which is assigned the number 271. While a standardized framework of request/response transactions persists, customizations to the particular data format of EDI messages involved are not uncommon across different business cases. An EDI file involved, therefore, can be said to consist of a combination of data and rules that are required for HIPAA standards conformance.

A part of a successful transition outcome, then, can be a holistic and efficient test tool that simulates a real world transaction environment, and simulates an accurate output. Such a capable tool can perform its function when input with one or more or any existing or prospective test scenario, and the associated data, that an organization might reasonably expect to encounter in a HIPAA related transition, thereby providing accuracy in the transition process.

However, current approaches to transaction testing in the HIPAA compliance environment have no provision for managing scenarios through the definition of virtual templates, file analysis, comparison and generation, and managing associated data and entities, through for example, data mining that allows data to be correlated. A further problem associated with the transition process is the complexity of the ANSI X-12 EDI (electronic data interchange) terminology—it is hard for medical professionals without training or orientation related to EDI terminology to prepare or transfer test-case scenarios as the EDI standard is often obscure and hard to grasp.

An effective test tool, then, can be capable of circumventing traditional problems, and reduce dependency on the EDI subject matter expertise ordinarily required for testing. What is needed, then, is to allow users to define structures and constraints in their own language. Such structures and constraints defined can then be leveraged to generate test data, which, in combination with test case scenarios, are used to produce both request and response EDI files for automated testing.

Accordingly, there is a need for a holistic HIPAA transaction testing tool, comprehensible to both business and technical users that is able to manage both scenarios and data to produce request and response EDI files for automated testing.

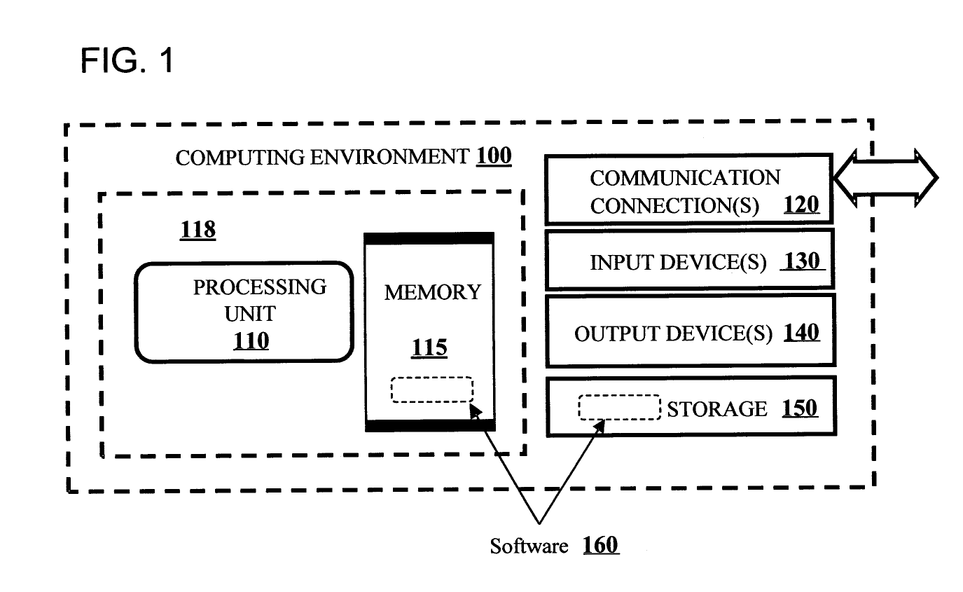

FIG. 1 illustrates a computing environment 100 capable of implementing the embodiments presented herein. FIG. 1 shows a computing environment 100 comprising a processing unit 110 and memory 115. In FIG. 1, this basic configuration 118 is included within a dashed line. The central processing unit 110 executes computer-executable instructions and can be a real or a virtual processor (e.g., which ultimately is executed on processor hardware). In a multi-processing system, multiple processing units execute computer-executable instructions to increase processing power and as such, multiple processors can be running simultaneously. The memory 115 can be volatile memory (e.g., registers, cache, RAM), non-volatile memory (e.g., ROM, EEPROM, flash memory, etc.), or some combination of the two. The memory 115 can store software 160 that can, for example, implement the technologies described herein. The computing environment 100 also comprises a communication connection 120, an input device 130, an output device 140, and a processor readable storage medium 150, in operable communication with the processing unit 110, is depicted.

A computing environment can have additional features. For example, an interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

The computing environment runs a software 160, the software 160 stored on a computer readable storage medium, and comprising one or more programming instructions stored in the processor readable storage medium, the programming instructions suitable for managing a healthcare systems transition.

The storage 150 can be removable or non-removable, and includes magnetic disks, magnetic tapes or cassettes, CD-ROMs, CD-RWs, DVDs, or any other medium which can be used to store information and that can be accessed within the computing environment 100. The storage 150 stores instructions for the software 160 and data, which can implement technologies described herein.

The input device(s) 130 can be a touch input device, such as a keyboard, keypad, mouse, touch screen display, pen, or trackball, a voice input device, a scanning device, or another device, that provides input to the computing environment 100. For audio, the input device(s) 130 can be a sound card or similar device that accepts audio input in analog or digital form, or a CD-ROM reader that provides audio samples to the computing environment 100. The output device(s) 140 can be a display, printer, speaker, CD-writer, or another device that provides output from the computing environment 100.

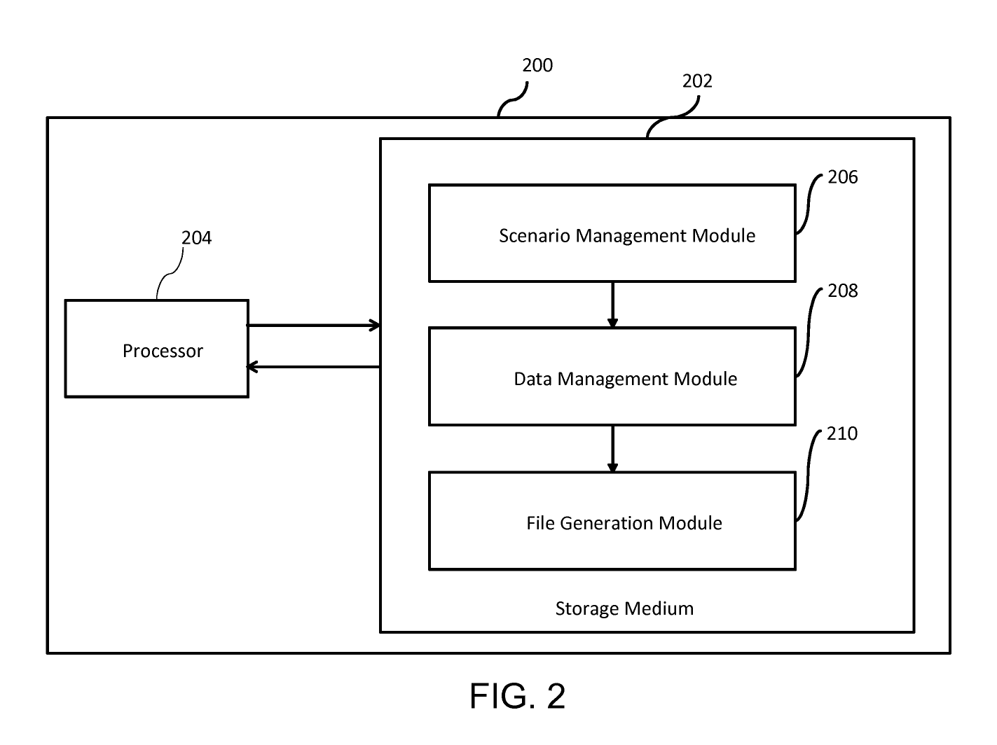

As additionally illustrated in FIG. 2, in the computing environment 200, the storage medium 202 in operable communication with the processor 204 contains at least the programming instructions operable for implementing a scenario management module, as in a block 206, a data management module, as in a block 208, and a file generation module, 210. The operation of embodiments of each of these modules is described in further detail below.

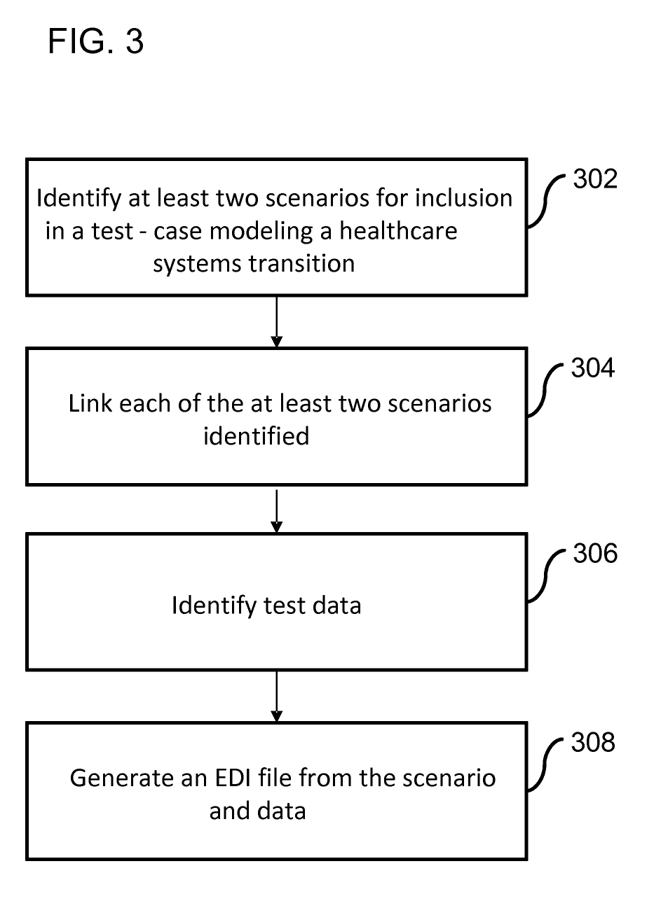

More specifically, an implementation of a systems testing tool that facilitates a healthcare systems transition is described with reference to FIG. 3. Firstly, the selection of one or more test case scenarios is detailed. Specifically, such scenarios can include various customer specific or business model specific rules which specify the organization of data. In a block 302, then, at least two scenarios for inclusion identified, and, as in a block 304, the scenarios are linked. Further, as in a block 306, test data is identified, and, finally, as in a block 308, one or more EDI files are generated from the combination of test-case scenarios and the data they organize. The overall function of the test tool, then, can be considered in terms of scenario management and data management.

Test case scenarios, in this context, can be defined as a collection of rules that define, or identify, a unique business case. Given that the testing tool deals in the manipulation of one or more electronic data interchange files, it is evident that these scenarios are either pre-loaded into the tool or extracted from an EDI file that is compliant with HIPAA 4010 or HIPAA 5010 standards.

In either of these instances, the selection of a scenario can be dependent on, as in an exemplary embodiment, an analysis of test-case requirements in an attempt to establish the nature of a scenario suitable for a model systems transition. Following such an analysis, one or more scenarios can be reviewed and selected on the basis of said review. Such a review would generally include a comparative analysis between one or more scenarios and the associated test-cases' requirements that were obtained in the analysis stage. Scenarios involved in the review can, in some embodiments, have been pre-loaded, provided ‘out-of-the-box’, or be otherwise available to the customer as a default scenario set. Predefined test-case scenarios of this sort can be stored on a computer readable storage medium and accessible thereby, or they can be stored on a remote machine accessible through a communications network.

Were such pre-loaded scenarios to prove inadequate in comparison with test-case requirements, new scenarios can be defined and added, or existing scenarios can be modified. Specifically, scenarios can be customized by the tool by means of one or more of the following operations:

Firstly, making a situational loop/segment/element in the EDI file mandatory. Secondly, setting bounds (e.g. minimum and/or maximum bounds) for repeats of a loop or segment or element in the EDI file. Thirdly, restricting the values allowed for an element in the EDI file, and, finally, allowing the user to define the varying nodes, such as the loop /segment/element, in the EDI file. The final option reflects change that is effected when user customization is desired.

Any new or modified scenario can have its rules validated, and one or more or any conflicts, if present, pointed out. For example, if a data rule is specified on an element, an ordinal rule cannot be, or, if a parent element is excluded, then a rule operating on the element may become unavailable. Conflicts of this nature can be handled by means of rule validation.

Test-case scenarios can, additionally, be modified, deleted, copied or otherwise added or made accessible or inaccessible. A scenario can also be tagged with a name, and referred to by said name thereafter. For example, a scenario can be tagged in accordance with a desired nomenclature for a set of rules it models.

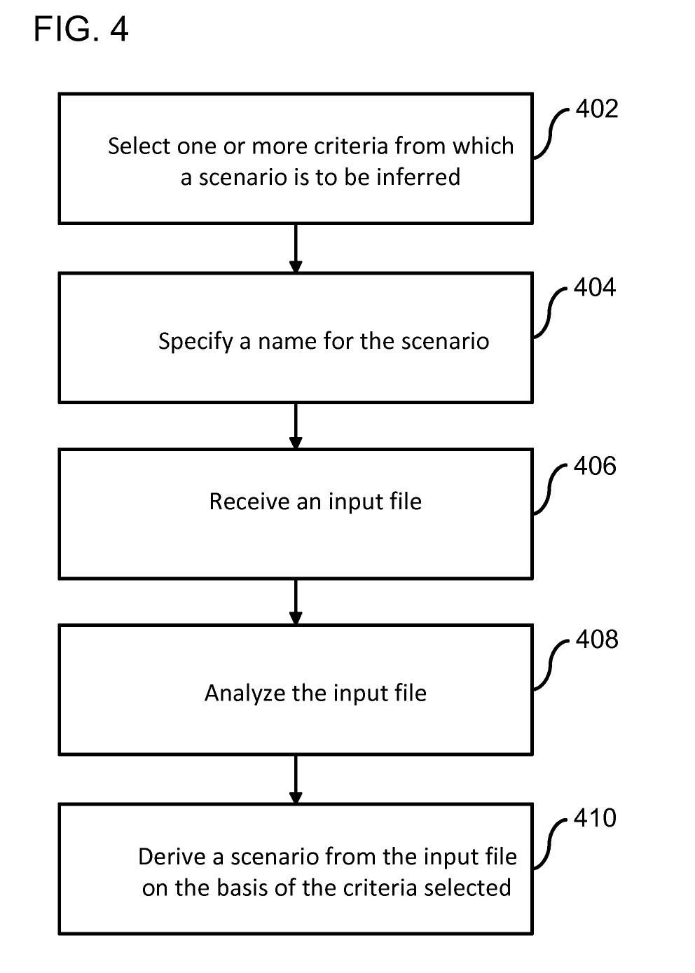

In an additional embodiment, scenarios can be added to the test tool by means of a scenario inference operation. In order to construct an inferred scenario, an input set of EDI files are analyzed to infer one or more scenarios for import. The input set of EDI files are one or more EDI files that constitute a standard, HIPAA 4010 or 5010 compliant, transaction type. They can be EDI files involved in an eligibility request/response transaction, for example. Referring now to FIG. 4, this input set, then, is analyzed by selecting the transaction type to which the input set of files belongs. Then, as in a block 402, one or more criteria are selected from which a scenario can be inferred. These criteria are derived from data in the EDI files, and can include loops, segments, or elements present therein. Then, as in a block 404, the one or more putative scenarios are grouped and named, and can be saved as a file and used as input for scenario inference, as indicated in a block 406. Then this file is analyzed, as in block 408, to check whether one or more or any new rules inferred from the criteria can be mapped to extant rules. Then one or more scenarios are then derived from the input file, as in a block 410. These scenarios can be stored, and a report detailing them generated if so desired by a user. The comparison report can contain information that highlights one or more missing rules which, if added to the one or more scenarios being compared, can render them equivalent. Such an operation has the benefit of increasing reusability of existing test files, particularly when they are compared with predefined scenarios.

Referring again to FIG. 3, identification of the test data, as disclosed in a block 306, is done for the generation of an output EDI file. Identification, however, is a multi-stage process that can involve data entity definition, data instance creation, correlation of data instances and association of these instances with the previously defined entities.

More substantially, entities are logical data blocks that correspond to a logical block in the HIPAA transaction tree, i.e. they are data blocks consisting of or comprising one or more EDI loops, segments or elements. They are, in effect, user friendly data blocks which hide the complexity of a transaction structure, and are generally mapped to HIPAA transaction data elements. Creating entities is complex, and usually involves input from EDI experts. In an example embodiment, they can be added, edited, or otherwise modified to create a logical structure for HIPAA transactions. In sum, entities are self-contained and consistent and can include real time data that are to be populated into an output EDI file.

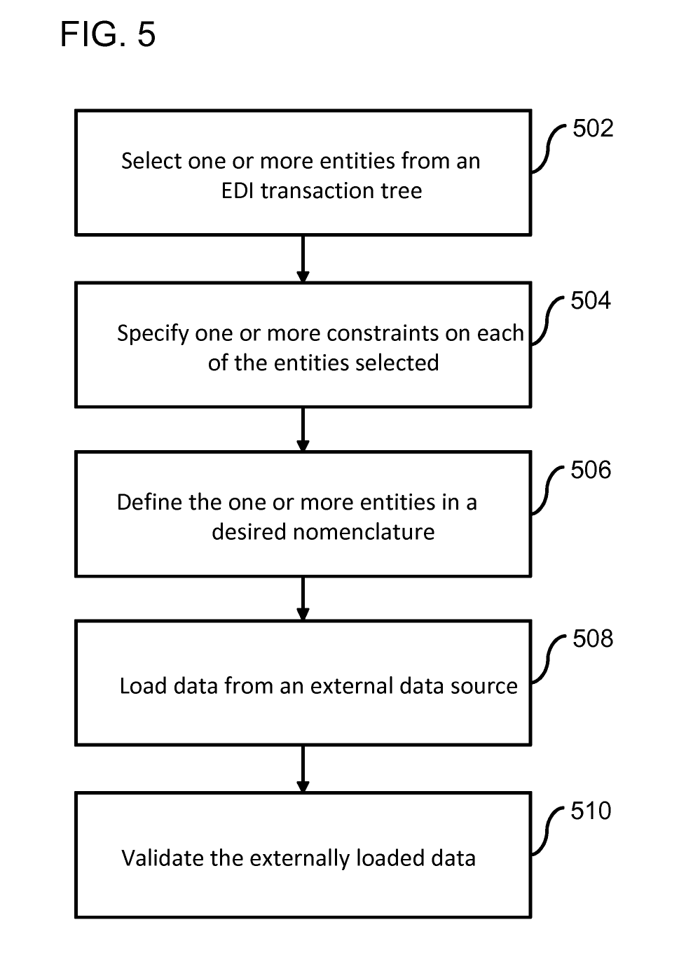

Referring now to FIG. 5, as in a block 502, one or more entities are first selected. These entities are generally extracted from the EDI transaction tree, and can be identified at one or more or any of the field, segment, or element levels of the EDI transaction tree. In an embodiment, one or more data entities can be predefined, or provided ‘out-of-the-box’ in the testing tool. Such a measure can save a tester the effort of defining data entities from scratch.

In an exemplary embodiment, additionally, one or more or any existing data entities are checked to see if they are carrying the same concept across transactions, e.g. multiple ‘patient’ entities across transactions, and they are matched if so. For example, a subscriber entity in a 270 transaction can be matched with a subscriber entity across an 837 transaction. Matched data entities can then be used to populate the tool.

Then, as in a block 504, one or more constraints on each of the entities selected can be specified. When constraints are specified against the aforementioned ‘Patient’ entity, for example, the ‘Patient’ entity can be restricted to a set of specified values, or made non-editable, etc. Additionally, when these data are provided from an external source, they are subject to one or more or any previously specified rules, or constraints, as well.

Then, as in a block 506, data entities can be named, or defined, under a user defined name. Names for entities provided by the EDI standard can be mapped to a user defined nomenclature, for example.

Then, data from an external data source are loaded, and one or more data instances created thereby. These data instances are associated with each entity, and, as such, each data entity can be reviewed to check whether there are extant data instances with which it is associated. In some aspects, data entities that are predefined can carry similarly predefined data instances. If no data instances are associated with an existing entity, or it is desired to define a new instance for an entity, a data instance can be created by means of loading data from the external source, as in a block 508 of FIG. 5. In some embodiments, these data sources can include user input, a database or a structured file, such as a spreadsheet. These datasets, then, can comprise data that are used to create an EDI file. The data management module described herein gathers and organizes these data, which can then be used to generate an EDI file output, or stored. Data once extracted can be used across one or more or all transaction types and scenarios, and can be used in the creation or modification of data entities.

Specifically, data are mapped against an entity to be used during EDI file generation. For example, an entity can be defined as a ‘Patient’, and a transaction file associated with the ‘Patient’ can contain such records as name, age, or other records. These records are mapped against the dataset provided, and used, subsequently, in EDI file generation.

The identification of data can include, as in a block 510, validation of the externally loaded data. Validation generally involves checking the application of the constraints defined in the data entity. For example, one or more fields in the data entity can be disabled in validation, and no external data can, consequently, be accepted for those fields. Other examples of the effect the application of a validation can include instances where, if a data entity defines a field as non-editable, and a default value is provided, then the default value will not be tampered with. If the ‘Patient’ entity is marked as non-editable, for instance, it will maintain its default data, regardless of external input. A further effect of a validation can include the automatic insertion of a default value for a field where the presence of such a value is expected (e.g. necessary), but missing.

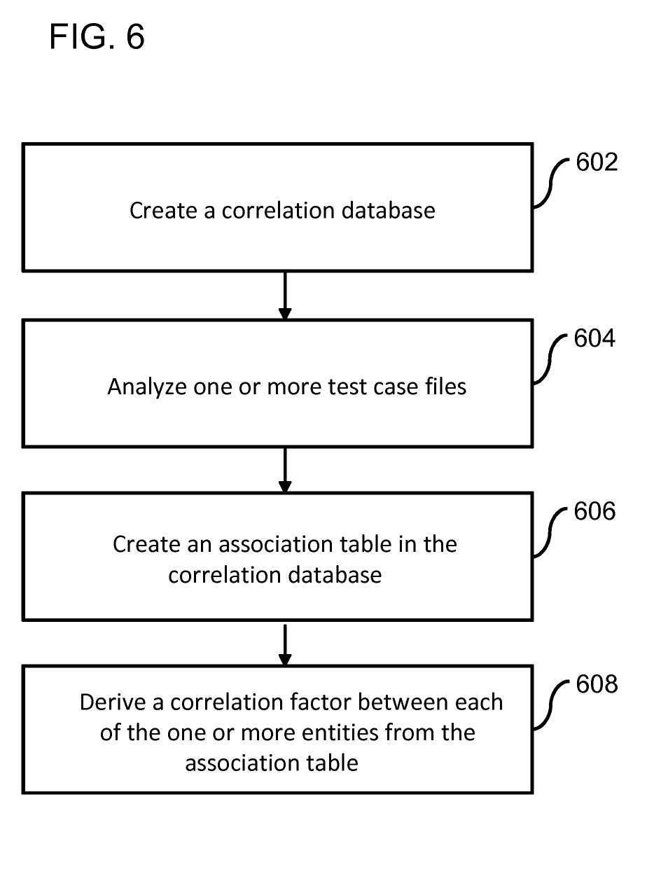

Referring now to FIG. 6, an exemplary embodiment incorporating the above can include the creation of a correlation database, as in a block 602, the correlation database comprising one or more correlation parameters indicating a correlation between the one or more data instances, and, further, the analysis of a set of any existing test EDI files, as in a block 604, as well as the creation of an association table in the correlation database, as in a block 606, wherein the association table comprises one or more entities and one or more correlation parameters detailing a frequency of occurrence of each of the one or more entities in the one or more test case scenarios and, finally, the derivation of a correlation factor between each of the one or more entities from the association table, as in a block 608.

Like a scenario matching and inference function, the use of correlation parameters can salvage significant utility from existing test files, and simplify a standards transition as a result. For example, some organizations can have extant test files in the HIPAA 4010 format—files that that they use for testing their existing systems. Some of these files can be negative test cases, and some positive test cases. When a correlation analysis is to be performed, these test files are analyzed and an association table consequently created. For example, given three entities—‘hospital’, ‘doctor’ and ‘subscriber’; an entry is made for each of these in the association table, noting how many times they occur in the test files, and, equally, how many times they occur in conjunction with each other. To illustrate, if, following analysis, a count of the total number of occurrences by a ‘Subscriber X’ entity=10, and, similarly, a ‘Hospital A’ count=7, a ‘Hospital B’ count=3, ‘Doctor A’ count=6, ‘Doctor B’ count=2, and a ‘Doctor C’ count=2, then it follows that subscriber X is strongly positively correlated with Hospital A, and strongly negatively correlated with Hospital B.

When ‘Subscriber X’ is used as a data entity in a positive test case then, ‘Hospital A’ can be recommended, or automatically chosen, as a data entity for the scenario, i.e. a first entity can be recommended for inclusion in any test case scenario where a second entity that it is strongly correlated with is included. The same process can be applied across one or more or all entities, or other logical data blocks, that are included in the test files, as well as scenarios therein. For the generation of a negative test case scenario the same concept applies in reverse. Strongly correlated entities can thus be combined to form a positive test case, or weakly correlated entities combined similarly to form a negative test case. Reuse is also encouraged through the translation of one or more entities, across transactions, which are strongly correlated to a similar entity set.

EDI file generation involves generating different combinations of EDI files for a given transaction scenario. The generated EDI file, or files, has many data blocks and each block has fixed values. The EDI file is structured based on the scenario rule applied on the data. Constraints include the HIPAA specification, including the HIPAA ruleset, and additionally, rules associated with the specific business scenario, as well as that of real-time data gathered, and other constraints. The number of files generated depends on the data present for each combination for a given transaction.

In a disclosed embodiment, for example, the generation of EDI files involves, generally, looping through scenario rules, associating data with the data entities accordingly and generating an EDI portion that might be split over multiple files or contain repetitive data based on the elements therein.

In accordance with disclosed embodiments of the described technologies, as will be appreciated by those ordinary skilled in the art, the foregoing example, demonstrations, and method acts can be implemented by suitable code on a processor base system, such as a general purpose or special purpose computer. It should also be noted that different implementations of the present technique can perform some or all of the acts described herein in different orders or substantially concurrently, that is, in parallel. Furthermore, the functions can be implemented in a variety of programming languages. Such code, as will be appreciated by those of ordinary skilled in the art, can be stored or adapted for storage in one or more tangible machine readable media, such as on memory chips, local or remote hard disks, optical disks or other media, which can be accessed by a processor based system to execute the stored code. For instance, the instructions can be electronically captured via optical scanning of a medium, then compiled, interpreted or otherwise processed in a suitable manner if appropriate, and then stored in a computer memory.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

The description herein is presented to enable a person of ordinary skill in the art to make and use the described technologies and is provided in the context of the requirement for obtaining a patent. The present description includes the best presently-contemplated method for carrying out the presently described technologies. Principles of the described technologies can be applied to other embodiments, and some features of the herein described technologies can be used without the corresponding use of other features. Accordingly, the herein described technologies are not intended to be limited to the embodiments shown but are to be accorded the widest scope consistent with the principles and features described herein.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A computer implemented method for managing testing for a healthcare systems transition, the method comprising:
identifying at least two scenarios for inclusion in a test-case modeling a healthcare systems transition, wherein:
a scenario of the at least two scenarios comprises a set of business specific rules that control the test-case; and
the at least two scenarios are identified on the basis of an analysis of one or more requirements associated with the healthcare systems transition;
linking respective scenarios of the at least two identified scenarios;
identifying test data for inclusion in the test-case, wherein the test data to be included comprises one or more data entities, an entity being a representation of a discrete data set, and one or more data instances associated with respective entities of the one or more data entities; and
generating one or more EDI files from the linked scenarios and the included test data.

2. The method as claimed in claim 1, further comprising analyzing an input set of electronic data interchange files to infer one or more scenarios for import.

3. The method as claimed in claim 2, wherein inferring one or more scenarios for import comprises:
selecting one or more criteria from which one or more scenarios may be inferred;
specifying a name for respective of the one or more scenarios;
receiving an input file from which the one or more scenarios is to be inferred;
analyzing the input file; and
deriving the one or more scenarios thereby, wherein one or more rules are derived on the basis of the one or more criteria selected.

4. The method as claimed in claim 1, wherein one or more test case scenarios are predefined.

5. The method as claimed in claim 1, wherein at least one scenario of the at least two scenarios is blank and at least one scenario of the at least two scenarios is non-blank and generating the output EDI file on the basis of the at least one non-blank scenario and the included test data thereby.

6. The method as claimed in claim 1, further comprising modifying one or more rules in a test-case scenario.

7. The method as claimed in claim 6, further comprising validating a modified rule in the test-case scenario.

8. The method as claimed in claim 1, further comprising tagging a test-case scenario with a desired name.

9. The method as claimed in clam 1, further comprising using the one or more generated EDI files for testing.

10. The method as claimed in claim 1, wherein identifying data associated with the one or more test-case scenarios further comprises:
selecting one or more entities from an EDI transaction tree;
specifying one or more constraints on respective entities of the one or more entities selected;
defining the one or more entities selected in a desired nomenclature;
loading data from an external data source and creating one or more data instances thereby, wherein at least one data instance is associated with each of the one or more entities; and
validating the externally loaded data.

11. The method as claimed in claim 10, wherein one or more entities and their associated data instances are predefined.

12. The method as claimed in claim 10, wherein the external data source from which a data instance is populated comprises manual input of data by a user, a database, a spreadsheet, or any combination thereof.

13. The method as claimed in claim 10, further comprising:
creating a correlation database, the correlation database comprising one or more correlation parameters indicating a correlation between the one or more data instances;
analyzing one or more test files;
creating an association table in the correlation database, wherein the association table comprises one or more data instances and one or more correlation parameters detailing a frequency of occurrence of respective data instances of the one or more data instances in the one or more test case files; and
deriving a correlation factor between the respective data instances of the one or more data instances from the association table.

14. The method as claimed in claim 13, further comprising combining one or more instances on the basis of their associated correlation factor, wherein one or more strongly correlated instances are combined to form a positive test case and one or more weakly correlated entities are combined to form a negative test case.

15. The method as claimed in claim 13, further comprising providing a recommendation for the inclusion of at least one instance in a test case, wherein the instance that is recommended for inclusion is strongly correlated with one or more instance that are present in the test case scenario.

16. The method as claimed in claim 13, further comprising translating one or more instances which serve a similar purpose across one or more transactions.

17. The method as claimed in claim 16, further comprising combining the one or more data instances with the correlation factor, and producing one or more electronic data interchange files thereby.

18. The method as claimed in claim 13, wherein generating the one or more EDI files comprises:
analyzing one or more rules provided by the linked scenarios;
associating data with one or more entities on the basis of the rules provided; and
generating the one or more EDI files thereby.

19. A system for managing testing for a healthcare systems transition, the system comprising:
a processor readable storage medium in communication with a processor, wherein the processor readable storage medium contains one or more programming instructions whereby the processor is operably configured to implement:
a scenario management module adapted to manage one or more test-case scenarios, wherein a scenario comprises a set of business specific data against which a set of rules is applied, the management of one or more scenarios comprising:
identifying at least two scenarios for inclusion in a test-case modeling a healthcare systems transition, wherein:
a scenario comprises a set of business specific rules that control the test-case; and
the at least two scenarios are identified on the basis of an analysis of one or more requirements associated with the healthcare systems transition; and
linking each of the at least two identified scenarios;
a data management module adapted to identify and include data in the test-case wherein:
the included test data comprises one or more data entities, an entity being a representation of a discrete data set; and
one or more data instances associated with each of the one or more data entities in combination with the one or more test-case scenarios; and
a file generation module adapted to generate one or more electronic data interchange (EDI) files from the included scenarios and data.

20. The system as claimed in claim 19, further comprising analyzing an input set of electronic data interchange files to infer one or more scenarios for import.

21. The system as claimed in claim 20, wherein inferring one or more scenarios for import comprises:
selecting one or more criteria from which one or more scenarios may be inferred;
specifying a name for the each of the one or more scenarios;
receiving an input file from which the one or more scenarios are to be inferred;
analyzing the input file; and
deriving one or more scenarios thereby, wherein one or more rules are derived on the basis of the one or more criteria selected.

22. The system as claimed in claim 19, wherein one or more test case scenarios are predefined.

23. The system as claimed in claim 19, further comprising modifying one or more rules in a test-case scenario.

24. The system as claimed in claim 23, further comprising validating a modified rule in the test-case scenario.

25. The system as claimed in claim 24, further comprising tagging the test-case scenario with a desired name.

26. The system as claimed in claim 25, further comprising using the generated EDI files for testing.

27. The system as claimed in claim 19, wherein identifying data associated with the one or more test-case scenarios further comprises:
selecting one or more entities from an EDI transaction tree, wherein an entity is a representation of a discrete data set;
specifying one or more constraints on respective entities of the one or more entities selected;
defining the one or more entities selected in a desired nomenclature;
loading data from an external data source and creating one or more data instances thereby, wherein at least one data instance is associated with respective entities of the one or more entities; and
validating the externally loaded data.

28. The system as claimed in claim 27, wherein the at least one data instance is tagged in accordance with a desired nomenclature.

29. The system as claimed in claim 27, wherein one or more entities and their associated data instances are predefined.

30. The system as claimed in claim 27, wherein the external data source from which a data instance is populated comprises manual input of data by a user, a database, a spreadsheet, or a combination thereof.

31. The system as claimed in claim 27, further comprising:
creating a correlation database, the correlation database comprising one or more correlation parameters indicating a correlation between the one or more data instances;
analyzing one or more test case files;
creating an association table in the correlation database, wherein the association table comprises one or more data instances and one or more correlation parameters detailing a frequency of occurrence of each of the one or more data instances in the one or more test case files; and
deriving a correlation factor between each of the one or more entities from the association table.

32. The system as claimed in claim 31, further comprising combining one or more data instances on the basis of their associated correlation factor, wherein one or more strongly correlated data instances are combined to form a positive test case and one or more weakly correlated data instances are combined to form a negative test case.

33. The system as claimed in claim 32, further comprising providing a recommendation for the inclusion of at least one data instance in a test case, wherein the data instance that is recommended for inclusion is strongly correlated with one or more data instances that are present in the one or more test case files.

34. The system as claimed in claim 33, further comprising translating one or more data instances which serve a similar purpose across one or more transactions.

35. The system as claimed in claim 31, further comprising combining the one or more data instances with the correlation factor, and producing one or more electronic data interchange files thereby.

36. The system as claimed in claim 31, wherein generating one or more EDI files comprises:
analyzing one or more rules provided by the linked scenarios;
associating data with one or more entities on the basis of the rules provided; and
generating one or more EDI files thereby.
